(19) United States
(12) Patent Application Publication
(10) Pub. No.: US 2014/0056474 A1
(43) Pub. Date: Feb. 27, 2014

(54) METHOD AND APPARATUS FOR RECOGNIZING POLYGON STRUCTURES IN IMAGES

(71) Applicant: MDi Touch LLC, Fremont, CA (US)

(72) Inventor: Mark E. Lichman, Fremont, CA (US)

(73) Assignee: MDi Touch LLC, Fremont, CA (US)

(21) Appl. No.: 14/010,359

(22) Filed: Aug. 26, 2013

Related U.S. Application Data
(60) Provisional application No. 61/693,171, filed on Aug. 24, 2012.

(51) Int. Cl. G06K 9/00

(52) U.S. Cl. CPC G06K 9/00624
USPC 382/103

(57) ABSTRACT

Technology is disclosed herein for recognizing and processing planar features in images such as walls of rooms. A method according to the technology receives a digital at a computing device. The computing device recognizes a polygonal region of the digital image corresponding to a planar feature of an object captured in the digital image. The computing device further processes the polygonal region of the digital image according to user instructions. The processed polygonal region of the digital image is visualized on a display of the computing device in real time.

### PRIORITY CLAIM

This application claims to the benefit of U.S. Provisional Patent Application No. 61/693,171, entitled “METHOD AND APPARATUS FOR IDENTIFYING WALLS FOR INTERIOR ROOM IMAGES”, which was filed on Aug. 24, 2012, which is incorporated by reference herein in its entirety.

### FIELD OF THE INVENTION

This invention relates generally to method and apparatus for image recognition, and in particular to a computing device for recognizing polygon structures in images.

### BACKGROUND

Technology advances have enabled the practical commercialization of increasingly sophisticated portable devices, such as tablet PCs (including the Apple iPad), and smartphones. Smartphones, in particular, are mobile phones offering advanced computing capabilities and connectivity, which may be thought of as handheld computers integrated within a mobile telephone. Smartphones are particularly characterized in that the user is able to install and run a wide range of advanced applications, based on sophisticated operating system software that provides a platform for application developers. Popular smartphone operating system platforms include Symbian OS, the Blackberry OS, iOS (used by the Apple iPhone and iPad devices), Android, and the Windows Phone OS. Depending upon the device and operating system, third-party applications (commonly termed ‘apps’) may be widely available for download and installation, or may be available from device and/or OS specific services.

With the computing power and a built-in high resolution camera, a modern smartphone can capture images and process these images for various purposes. For instance, the smartphone can perform a face authentication process on a photographed image by identifying the face of which of persons registered in advance the face of a person present in the photographed image corresponds to. To achieve the facial recognition, the smartphone can use various image recognition techniques, such as performing face detection for extracting an image corresponding to a face part of a person from each of photographed images, comparing the detected image corresponding to the face part with each of a plurality of face images registered in advance, and searching the face image a matching degree of which is equal to or higher than a standard.

In another example, a computing device can extract a user's desired image from a scene of a sport picture of, for example, tennis, such as “successful passing shot” and “successful smash”. Such methods include methods of recognizing the substance of such an image by recognizing a “successful passing shot” section, a “successful smash” section and a like section of picture information one by one, or by extracting positions of respective of a ball, players and court lines and totally judging a change with time in spatial correlations among the extracted positions by the computing device.

### SUMMARY

The technology introduced here provides a method for recognizing structural polygons in digital images. For instance, the method can detect room corners and room walls from the digital images. The room structures captured in the digital images are identified in forms of polygons. The method can be used to identify other objects in digital images, including but not limited to furniture, decoration, lighting, appliance, etc. The method applies to digital image formats, including but not limited to, pixel based and vector based formats.

In accordance with the technology introduced here, therefore, a method for of identifying walls for interior room images (or other types of architectural spaces) is provided. The method analyzes the image to detect edges and lines on the images. Using the lines and intersections of the lines, the method determines polygons corresponding to features such as the walls. The method further processes the polygons according to user instructions.

Further in accordance with the technology introduced here, therefore, a method is provided. The method according to the technology receives a digital at a computing device. The computing device recognizes a polygonal region of the digital image corresponding to a planar feature of an object captured in the digital image. The computing device further processes the polygonal region of the digital image according to user instructions. The processed polygonal region of the digital image is visualized on a display of the computing device in real time.

Further in accordance with the technology introduced here, therefore, another method is provided. The method includes steps of receiving, at a computing device, a signal indicating a point of interest on a digital image; determining, at the computing device, virtual lines on the digital image corresponding to edges of brightness discontinuities on the digital image; identifying a polygon reference including virtual lines and intersections enclosing at least a portion of a color segmentation including the point of interest; recognizing, at the computing device, a polygonal region of the digital image corresponding to a planar feature of an object captured in the digital image, the polygonal region including the polygon reference; and changing an image property of the polygonal region of the digital image based on a user input.

Further in accordance with the technology introduced here, therefore, a computing device is provided. The computing device includes a process, a camera component, a display component, an input component, and a memory. Other aspects of the technology introduced here will be apparent from the accompanying figures and from the detailed description, which follows. The camera component is configured to capture a digital image of an object. The display component is configured to visualize the digital image and a processed version of the digital image. The input component is configured to receive a user input indicating a point of interest on the digital image. The memory stores instructions which, when executed by the processor, cause the computing device to perform a process for feature recognition and processing. The process includes recognizing a polygonal region of the digital image corresponding to a planar feature of the object, the polygonal region including the point of interest; processing the polygonal region of the digital image in response to an instruction received from the input component; and visualizing the processed polygonal region of the digital image on the display component.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 is a block diagram showing a schematic configuration of a computing device for image recognition.

FIG. 2 is a block diagram illustrating an example network server communicating with client devices.

FIG. 3 illustrates an example of a process for recognizing a region of interest in an image and processing the region.

FIG. 4 illustrates an example of a process for recognizing polygonal regions in an image.

### DETAILED DESCRIPTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

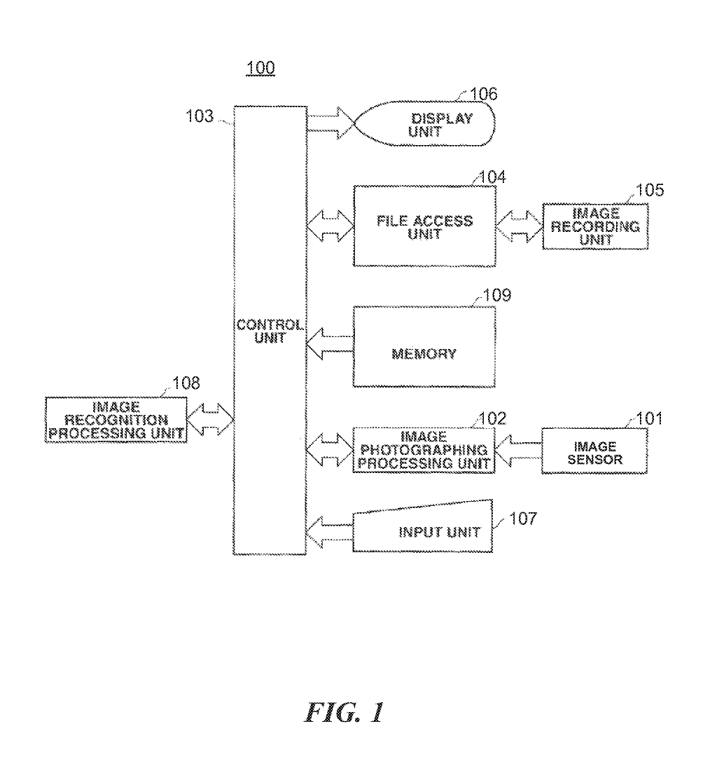

FIG. 1 is a block diagram showing a schematic configuration of a computing device for image recognition according to an embodiment of the present invention. The computing device 100 can be, e.g., a smartphone having a built-in camera. The computing device 100 includes an image sensor 101 and an image photographing processing unit 102. The image sensor 101 can include, e.g., a charge-coupled device (CCD) or a complementary metal-oxide-semiconductor (CMOS). The image photographing processing unit 102 includes various signal processing circuits for converting an output signal (a photograph signal output) from a drive circuit of the image sensor 101, performing various processes on the digital data, and generating image data (e.g. RGB or YUV data) on an object image picked up by the image sensor 101.

The image data generated by the image photographing processing unit 102 is transmitted to a control unit 103. In a recording mode, the image data is recorded in an image recording unit 105 as an image file via a file access unit 104. The image recording unit 105 can include recording medium such as a memory card of various types attachable/detachable to or from the digital camera. The recording medium can include a flash memory in the computing device 100. The file access unit 104 is an interface circuit for inputting or outputting image data to or from the image recording unit 105 serving as the recording medium.

The control unit 103 is configured to mainly include a CPU and peripheral circuits of the CPU and controls the overall operation performed by the computing device 100. The control unit 103 can include a CODEC (coder-decoder) compressing or expanding image data and performs both an image data compression process in the recording mode and a compressed data expansion process in a reproduction mode for reproducing a recorded image.

The computing device 100 includes a display unit 106, an input unit 107, an image recognition processing unit 108, a program memory 109, and a RAM 110.

The display unit 106 displays an image based on image data read from the image recording unit 105 in the reproduction mode. The display unit 105 can include, e.g., liquid-crystal display (LCD) or organic light-emitting diode (OLED) display. The display unit 106 can function as an electronic view finder by displaying a through-the-lens image of an object based on the image data generated by the image photographing processing unit 102 in a shooting standby state in the recording mode. The display unit 106 displays various setting screens for causing a user to set contents of a digital camera operation.

The input unit 107 is configured to detect user inputs. The input unit 107 can be, e.g. a touchscreen unit for user to interact with the computing device 100 by touching the screen with fingers or stylus. Such a touchscreen unit can be combined with the display unit 106 such that a user can touch contents displayed on the display unit 106. The control unit 103 sequentially detects an operation state of the inputs detected by the input unit 107.

The image recognition processing unit 108 recognizes certain information from the image data (object image) on the object picked up by the image sensor 101 and generated by the image photographing processing unit 102 by performing an image recognition process.

The memory 109 is a volatile or nonvolatile memory capable of programming stored data. The memory 109 can also serve as a working memory for the control unit 109. The memory 109 stores therein not only the data generated at the time of the control over the digital camera but also image data before compression, image data after expansion and programming data for image recognition.

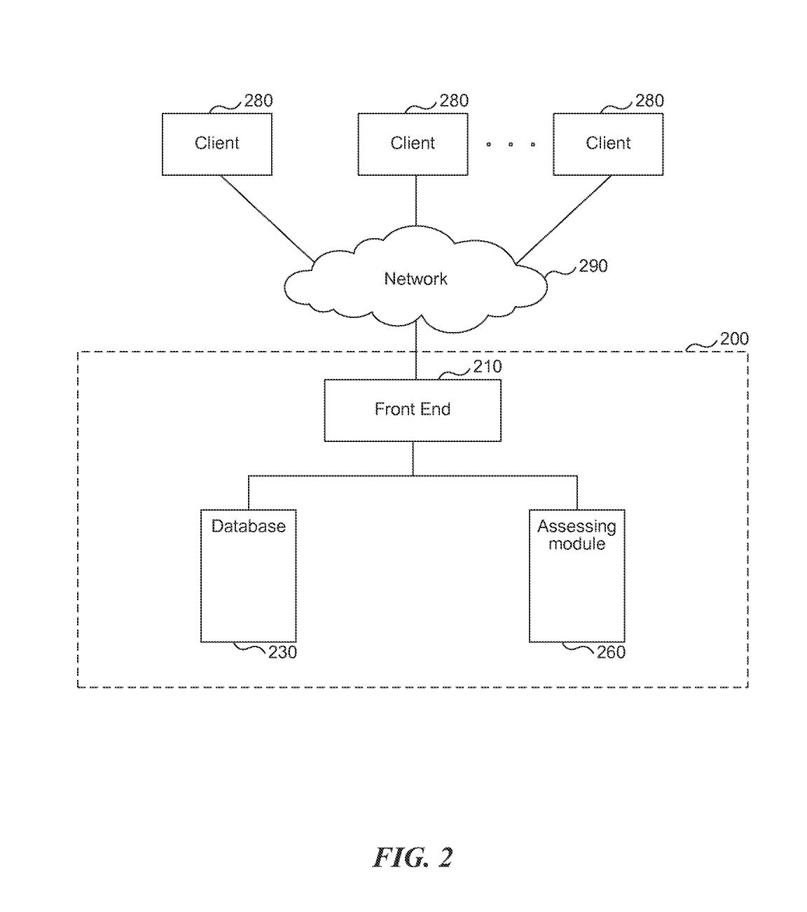

In some embodiments, the computing device can communicate with a remote server over a network to offload some computing tasks such as the image recognition. For instance, computing devices can function as clients to communicate with a network server. FIG. 2 illustrates an example network server 200 communicating with client devices 280. The network server 200 includes a front end 210. The front end 210 may interact with client devices 280 through a network 290. The client devices 280 may interact via different interfaces provided by the front end 210 to submit computing tasks to and retrieve results from the network server 200. For instance, if a client device 280 is a laptop computer running a web browser connected to the front end 210, the front end 210 can provide a HTTP service to interact with the laptop computer. If a client device 280 is a smart phone running a native platform application, the client device 280 provides information to the native platform application to list the available resources for the task.

The network server 200 can include a database 230 configured to record data associated with the task that the client devices 280 request. For instance, the database 230 can record the image data sent from the client devices 280 in order to analyze the image data. The network server 200 can further include an analysis module 260 configured to perform the image analysis tasks submitted by the client devices 280.

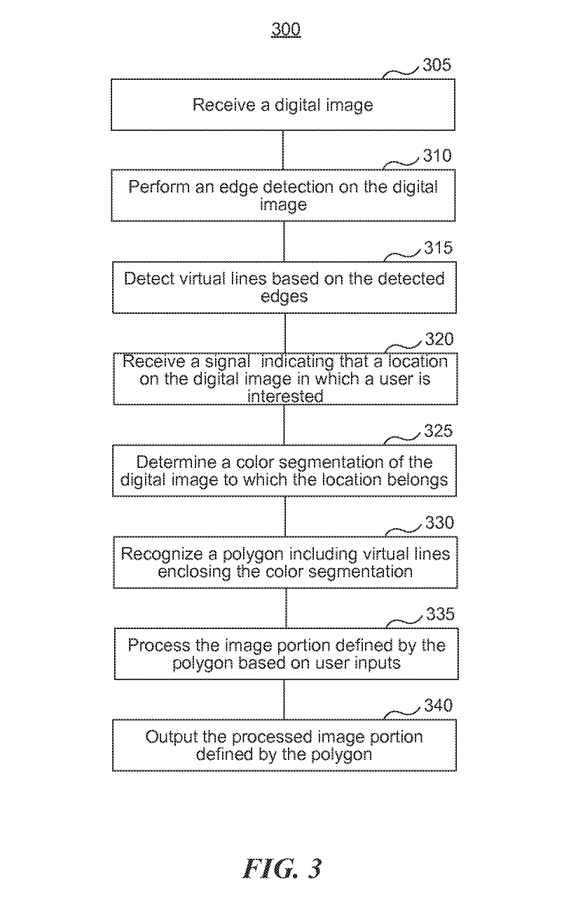

FIG. 3 illustrates an example of a process 300 for recognizing a region of interest in an image and processing the region. The process 300 starts at step 305, where a computing device receives a digital image. The digital image can be of various formats, e.g., JPG, GIF, PNG, etc. The format of the digital image can be, e.g., pixels based or vector based. The computing device may receive the digital image that is captured by a built-in camera of the computing device. Alternatively, the computing device may generate the digital image by itself without receiving any optical signal from environment. In some embodiments, the computing device may receive the digital image from another device (e.g., a computer, a camera, or a server) separate from the computing device.

At step 310, the computing device performs an edge detection on the digital image. For instance, the computing device analyzes the digital image and identifies points in the digital image at which the image brightness changes sharply (also referred to as discontinuities). The points at which image brightness changes sharply are organized into a set of curved line segments termed edges. The computing device can use various edge detection methods. For example, the computing device can use Canny, Seibel, or Laplace algorithms for edge detections.

At step 315, the computing device detects virtual lines based on the detected edges. The virtual lines separate color segmentations of the digital image. Unlike the edges, the virtual lines extend from the edges and extend across the digital image.

Each color segmentation of the digital image is a continuous region on the image that contains close colors or the same color. In some embodiments, the computing device uses square pixel windows to generate virtual lines based on statistical correlations of no-zero valued pixels in the windows.

At step 320, the computing device receives a signal indicating that a location on the digital image in which a user is interested. For instance, the signal may include a coordinate of the digital image that the user clicks using a mouse or the user touches on a touch screen.

At step 325, the computing device determines a color segmentation of the digital image to which the location belongs.

At step 330, the computing device recognizes a polygon including virtual lines enclosing the color segmentation.

At step 335, the computing device processes the image portion defined by the polygon based on user inputs. For instance, the computing device may receive a user input instructing to change the color. According to the user input, the computing device can change the color of the image portion defined by the polygon.

At step 340, the computing device outputs the processed image portion defined by the polygon. For instance, the computing device may visualize the processed image portion defined by the polygon on its display, so the user can review instantly the visual effect of polygon defined portion of the image changing colors. Alternatively, the computing device may output by transferring the data of the processed image portion to another device. In turn, the other device can visualize the processed image portion defined by the polygon on a display.

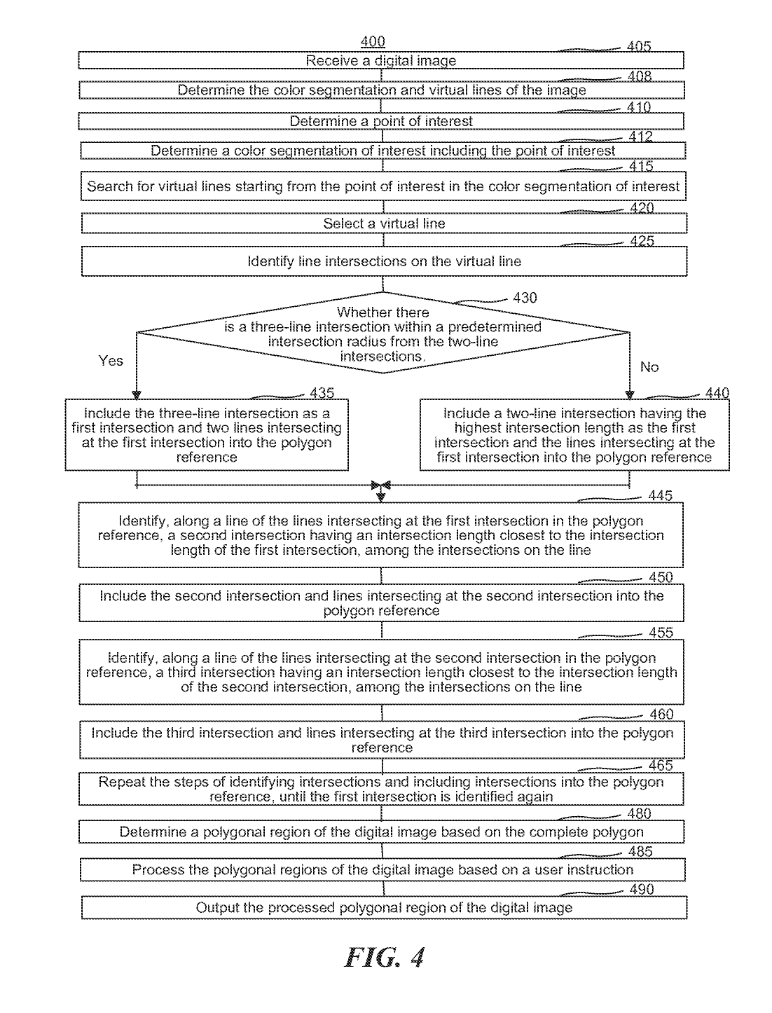

The polygon recognition process is described in details in FIG. 4. FIG. 4 illustrates an example of a process 400 for recognizing polygonal regions in an image. At step 405 of the process 400, a computing device receives an image. At step 408, the computing device determines the color segmentation and virtual lines of the image. The virtual lines detection and the color segmentation can be performed, e.g., by the process illustrated in FIG. 3.

At step 410, the computing device determines a point of interest. The point of interested may be decided by a user via a user input, e.g., by a user touching a spot of the digital image displayed on a touch screen.

At step 412, the computing device determines a color segmentation of interest including the point of interest. The color segmentation of interest may be determined, e.g., based on a user input that the user touch a point (point of interest) of the image within that color segmentation.

At step 415, the computing device searches for virtual lines starting from the point of interest in the color segmentation of interest. In some embodiments, the starting point can be the point of the image that the user has touched. The computing device may search for the virtual lines along four cardinal directions on the digital images, including the north, south, east and west directions.

The computing device continues to identify a polygon reference including virtual lines and intersections enclosing at least a portion of a color segmentation including the point of interest. At step 420, the computing device selects a virtual line. At step 425, the computing device identifies line intersections (also simply referred to as intersections) on the virtual line. The line intersections can be two-line intersections, at which two lines intersect.

At step 430, the computing device determines whether there is a three-line intersection within a predetermined intersection radius from the two-line intersections. If there is a three-line intersection within a predetermined intersection radius from the two-line intersections, at step 435 the computing device includes the three-line intersection as a first intersection and two lines intersecting at the first intersection into the polygon reference. The computing device may choose to include two intersecting lines among the three intersecting lines that are closer to the point of interest into the polygon reference.

For example, based on the identified three-line intersection, the computing device can determine bridge lines between ends points of the real lines intersect at the identified three-line intersection. The computing device can identify a bridge line among the bridge lines that is closest to the point of interest. The computing device can choose two virtual lines extending from the real lines that are connected by the closest bridge line into the polygon reference.

If there is no three-line intersection within the predetermined intersection radius from the two-line intersection, at step 440, the computing device includes a two-line intersection having the highest intersection length as the first intersection and the lines intersecting at the first intersection into the polygon reference. An intersection length of an intersection is a sum of lengths of two real lines intersect at the intersection. Unlike the virtual lines extend across the digital images, the lengths and positions of the real lines are consistent with lengths and positions of the edges.

The computing device follows intersecting lines of intersections in the polygon reference to include additional intersections having intersection lengths close to the intersection length of the first intersection until the first intersection is identified again. At step 445, the computing device identifies, along a line of the lines intersecting at the first intersection in the polygon reference, a second intersection having an intersection length closest to the intersection length of the first intersection, among the intersections on the line. At step 450, the computing device includes the second intersection and lines intersecting at the second intersection into the polygon reference.

Similarly, at step 455, the computing device identifies, along a line of the lines intersecting at the second intersection in the polygon reference, a third intersection having an intersection length closest to the intersection length of the second intersection, among the intersections on the line. At step 460, the computing device includes the third intersection and lines intersecting at the third intersection into the polygon reference. At step 465, the computing device repeats the steps of identifying intersections and including intersections into the polygon reference, until the first intersection is identified again. Once a first intersection is identified again, a closed polygon reference is identified.

Optionally, the computing device can further determine whether a polygon reference is finalized. The computing device determines an x-axis threshold and a y-axis threshold based on the x-axis and y-axis differences of coordinates of intersections. If two intersections having a-axis difference that is below the x-axis threshold or having y-axis difference that is below the y-axis threshold, a line is drawn between the two intersections to divide the polygon references into two polygon references. One of the two divided polygon references that include the point of interest can be used as the polygon reference for the following steps of the process.

The computing device continues to step 480 to determine a polygonal region of the digital image based on the complete polygon. If the polygon candidate is not complete, the computing device goes to the step 460 to find another line along a different direction.

After the polygonal region of the image is determined, at step 485, the computing device processes the polygonal regions of the digital image based on a user instruction. For instance, a user may instruct the computing device to change the color (or, e.g., hues or brightness) of the polygonal region of the image to another color. Accordingly, the computing device changes the colors (or, e.g., hues or brightness) of the polygonal region. Alternatively, the computing device may add an object (e.g. a picture frame) onto the polygonal region according to a user's instruction. The computing device can change various image properties includes color, brightness, hue, saturation, size, shape, or color temperature.

At step 490, the computing device outputs the processed polygonal region of the digital image. For instance, the computing device can visualize the processed polygonal region of the digital image on a display component of the computing device; so that a user instructs to change the color can instantly see the feedback of the region of the digital image changing color on a display component of the computing device. Alternatively, the computing device can transfer in real time the data of the processed polygonal region of the digital image to a display device separated from the computing device. The user can instantly see the color changing of the region of the image on the display.

Those skilled in the art will appreciate that the logic illustrated in FIGS. 3-4 and described above, may be altered in a variety of ways. For example, the order of the logic may be rearranged, substeps may be performed in parallel, illustrated logic may be omitted, other logic may be included, etc. Although the embodiment illustrated in FIG. 4 shows that a computing device conducts the steps of the process 400, in some other embodiments, some steps of the process 400 can conducted by, e.g., a network server such as the network server 200 illustrated in FIG. 2.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A method, comprising:
receiving, at a computing device, a digital image;
recognizing, at the computing device, a polygonal region of the digital image corresponding to a planar feature of an object captured in the digital image;
processing, at the computing device, the polygonal region of the digital image; and
outputting, from the computing device, the processed polygonal region of the digital image.

2. The method of claim 1, wherein the object is a room, and the planar feature of the object is a wall of the room.

3. The method of claim 1, wherein the digital image is captured by a camera component in the computer device.

4. The method of claim 1, further comprising:
receiving, at the computing device, a signal indicating that a user is interested in a location on the digital image.

5. The method of claim 4, wherein the polygonal region of the digital image includes the location.

6. The method of claim 4, wherein the signal indicating that the user touches the location on the digital image visualized on a display component of the computing device.

7. The method of claim 1, wherein the processing comprises:
changing, at the computing device, one or more color in the polygonal region of the digital image based on a user instruction.

8. The method of claim 1, wherein the outputting comprises:
visualizing, from the computing device, the processed polygonal region of the digital image on a display component of the computing device.

9. The method of claim 1, wherein the outputting comprises:
transferring, from the computing device, data of the processed polygonal region of the digital image to a display device.

10. A method, comprising:
receiving, at a computing device, a signal indicating a point of interest on a digital image;
determining, at the computing device, virtual lines on the digital image corresponding to edges of brightness discontinuities on the digital image;
identifying a polygon reference including virtual lines and intersections enclosing at least a portion of a color segmentation including the point of interest;
recognizing, at the computing device, a polygonal region of the digital image corresponding to a planar feature of an object captured in the digital image, the polygonal region including the polygon reference; and
changing an image property of the polygonal region of the digital image based on a user input.

11. The method of claim 10, further comprising:
receiving content data of the digital image.

12. The method of claim 10, wherein identifying a polygon reference comprises:
selecting a virtual line;
identifying two-line intersections on the virtual line;
If there is a three-line intersection within a predetermined intersection radius from the two-line intersections, including the three-line intersection as a first intersection and two lines intersecting at the first intersection into the polygon reference;
If there is no three-line intersection within the predetermined intersection radius from the two-line intersection, including a two-line intersection having the highest intersection length as the first intersection and the lines intersecting at the first intersection into the polygon reference; and
following intersecting lines of intersections in the polygon reference to include additional intersections having intersection lengths close to the intersection length of the first intersection until the first intersection is identified again.

13. The method of claim 12, wherein the following intersecting lines of intersections in the polygon reference comprises:
identifying, along a line of the lines intersecting at the first intersection in the polygon reference, a second intersection having an intersection length closest to the intersection length of the first intersection, among the intersections on the line;
including the second intersection and lines intersecting at the second intersection into the polygon reference;
identifying, along a line of the lines intersecting at the second intersection in the polygon reference, a third intersection having an intersection length closest to the intersection length of the second intersection, among the intersections on the line;
including the third intersection and lines intersecting at the third intersection into the polygon reference; and
repeating identifying intersections and including intersections into the polygon reference until the first intersection is identified again.

14. The method of claim 10, wherein the polygonal region includes multiple polygon references.

15. The method of claim 10, wherein the image property includes color, brightness, hue, saturation, size, shape, or color temperature.

16. The method of claim 10, wherein the changing comprises:
adding or removing an image feature to the polygonal region of the digital image based on a user input.

17. The method of claim 10, further comprising:
visualizing the changed polygonal region of the digital image in real time as a user inputs an instruction to the computing device.

18. A computing device, comprising:
a processor;
a camera component configured to capture a digital image of an object;
a display component configured to visualize the digital image and a processed version of the digital image;
an input component configured to receive a user input indicating a point of interest on the digital image; and
a memory storing instructions which, when executed by the processor, cause the computing device to perform a process including:
recognizing a polygonal region of the digital image corresponding to a planar feature of the object, the polygonal region including the point of interest;
processing the polygonal region of the digital image in response to an instruction received from the input component; and
visualizing the processed polygonal region of the digital image on the display component.

19. The computing device of claim 18, wherein the object includes an architectural space, and the digital image is an image of the interior of the architectural space.

20. The computing device of claim 18, wherein the planar feature of the object is a wall of an architectural space.

21. The computing device of claim 18, wherein the processing comprises:
changing color, brightness, hue, saturation, size, shape, or color temperature of the polygonal region of the digital image in response to an instruction received from the input component.
